(19) United States
(12) Patent Application Publication
(10) Pub. No.: US 2026/0302566 A1
(43) Pub. Date: Oct. 1, 2026

(54) ELECTRODE LAMINATE

(71) Applicant: HONDA MOTOR CO., LTD., Tokyo (JP)

(72) Inventors: Kizashi Iwakiri, Wako-shi (JP); Takuya Taniuchi, Wako-shi (JP); Terumi Furuta, Wako-shi (JP)

(21) Appl. No.: 19/578,982

(22) Filed: Mar. 26, 2026

(30) Foreign Application Priority Data
Mar. 31, 2025 (JP) 2025-059824
Mar. 3, 2026 (JP) 2026-033439

(51) Int. Cl. H01M 50/59; H01M 10/0525; H01M 10/0585; H01M 50/586

(52) U.S. Cl. CPC H01M 50/59; H01M 10/0525; H01M 10/0585; H01M 50/586

(57) ABSTRACT

An electrode laminate including positive electrode, solid electrolyte layer laminated on the positive electrode, and negative electrode laminated on the solid electrolyte layer, wherein, when A is a distance over which lithium ions diffuse within the solid electrolyte layer in a direction substantially perpendicular to a thickness direction of the electrode laminate from one end of the positive electrode, B is a distance from the one end of the positive electrode in the solid electrolyte layer to one end of the negative electrode in the direction substantially perpendicular to the thickness direction of the electrode laminate, and C is a distance from the one end of the positive electrode to the one end of the negative electrode in the negative electrode in the direction substantially perpendicular to the thickness direction of the electrode laminate, the A and the C satisfy the following formula (1):

A≤C (1).

### CROSS-REFERENCE TO RELATED APPLICATIONS

Priority is claimed on Japanese Patent Application No. 2025-059824, filed Mar. 31, 2025 and Japanese Patent Application No. 2026-033439, filed Mar. 3, 2026, the contents of both of which are incorporated herein by reference.

### BACKGROUND OF THE INVENTION

### Field of the Inventions

The present invention relates to an electrode laminate.

### Description of Related Art

In recent years, research and development of secondary batteries that contribute to improved energy efficiency has been conducted to ensure that more people can access affordable, reliable, sustainable and advanced energy. Among secondary batteries, all-solid-state batteries having excellent safety, lifespan, and output characteristics have been focused on (for example, refer to PCT International Publication No. WO2023/218218).

### SUMMARY OF THE INVENTION

In all-solid-state batteries, dendrites (dendrite crystals) derived from metal ions such as lithium ions may precipitate in the negative electrode layer during charging. In addition, for example, if the interface between the negative electrode layer and the solid electrolyte layer deteriorates when charging and discharging are repeated, there is a risk that abnormal precipitation including dendrites derived from metal ions will be promoted. When metal ions are precipitated on the ends of the solid electrolyte layer or the like, precipitated metals accumulate, which may cause short-circuiting between the positive electrode layer and the negative electrode layer or may cause local side reactions that increase the resistance inside the battery, and cycle characteristics may deteriorate.

In addition, in all-solid-state batteries, since metal ions diffuse within the solid electrolyte layer, it is thought that the diffusion radius of the metal ions varies depending on the thickness of the solid electrolyte layer. However, the relationship between the thickness of the solid electrolyte layer and the diffusion radius of metal ions has not been sufficiently investigated, and there is room for improvement in the structure that can achieve both an improvement in the energy density of the battery and an improvement in the durability of the battery.

In the cross section of the all-solid-state battery in the thickness direction, it is preferable that the dimensions of the positive electrode and the negative electrode match so that metal ions do not concentrate in the part of the negative electrode that does not face the positive electrode (hereinafter referred to as a “positive electrode non-facing part”). However, in the process of producing all-solid-state batteries, it is difficult to match the dimensions of the positive electrode and the negative electrode. Considering allowable dimensions of the positive electrode and the negative electrode, it is desirable for the negative electrode to be sufficiently larger than the positive electrode. However, in this case, the energy density of the battery decreases.

In addition, when the negative electrode is larger than the positive electrode, a metal precipitates in the positive electrode non-facing part. When the length of the positive electrode non-facing part is not sufficient, a metal precipitates in the positive electrode non-facing part, which may reduce the capacity retention rate of the battery.

An aspect of the present invention provides an electrode laminate in which the precipitation of a metal on a positive electrode side surface of the positive electrode non-facing part is inhibited in a positive electrode non-facing part when the all-solid-state battery is charged. The aspect of the present invention contributes to stabilizing battery performance and improving energy efficiency.

The present invention includes the following aspects.
[1] An electrode laminate including a positive electrode, a solid electrolyte layer laminated on the positive electrode, and a negative electrode laminated on the solid electrolyte layer,
   wherein, when A is a distance over which lithium ions diffuse within the solid electrolyte layer in a direction substantially perpendicular with respect to a thickness direction of the electrode laminate from one end of the positive electrode, B is a distance from the one end of the positive electrode in the solid electrolyte layer to one end of the negative electrode in the direction substantially perpendicular with respect to the thickness direction of the electrode laminate, and C is a distance from the one end of the positive electrode to the one end of the negative electrode in the negative electrode in the direction substantially perpendicular with respect to the thickness direction of the electrode laminate, the A and the C satisfy the following formula (1):

A≤C (1).

According to the above aspect, it is possible to inhibit the precipitation of metal ions on a positive electrode side surface of the negative electrode in a part of the negative electrode that does not face the positive electrode when the all-solid-state battery is charged. Therefore, a decrease in capacity retention rate of the all-solid-state battery including the electrode laminate can be minimized.
[2] The electrode laminate according to [1],
   wherein an intermediate layer is provided between the solid electrolyte layer and the negative electrode, and
   a larger one of the B and the C is equal to or larger than the A.

According to the above aspect, it is possible to inhibit the precipitation of metal ions on a positive electrode side surface of the negative electrode in a part of the negative electrode that does not face the positive electrode when the all-solid-state battery is charged. Therefore, a decrease in capacity retention rate of the all-solid-state battery including the electrode laminate can be minimized.
[3] The electrode laminate according to [1],
   wherein, in a case a precipitation rate of metal ions is considered to be 100% when the precipitation rate of metal ions precipitated from the positive electrode is equal to an increment in a thickness of a part of the negative electrode that faces the positive electrode or in a case a dissolution rate of metal ions is considered to be 100% when the dissolution rate of metal ions dissolved from the negative electrode is equal to a decrement in the thickness of the part of the negative electrode that faces the positive electrode, the A is derived based on a relationship 1 which is a relationship between a distance between the part of the negative electrode that faces the positive electrode and the positive electrode and a thickness of the solid electrolyte layer.

According to the above aspect, it is possible to inhibit the precipitation of metal ions on a positive electrode side surface of the negative electrode in a part of the negative electrode that does not face the positive electrode when the all-solid-state battery is charged. Therefore, short-circuiting between the negative electrode and the positive electrode can be prevented, and a decrease in capacity retention rate of the all-solid-state battery including the electrode laminate can be minimized. In addition, even if voids occur in the negative electrode or the solid electrolyte layer, short-circuiting between the positive electrode and the negative electrode can be prevented. In addition, it is possible to minimize the occurrence of metal ion dendrites on the surface of the negative electrode.

The electrode laminate according to [3], wherein the relationship 1 is derived from a relationship 2 which is a relationship between the precipitation rate of metal ions or the dissolution rate of metal ions and the thickness of the solid electrolyte layer and a relationship 3 which is a relationship between the precipitation rate of metal ions or the dissolution rate of metal ions and the distance between the part of the negative electrode that faces the positive electrode and the positive electrode.

According to the above aspect, it is possible to inhibit the precipitation of metal ions on a positive electrode side surface of the negative electrode in a part of the negative electrode that does not face the positive electrode when the all-solid-state battery is charged. Therefore, short-circuiting between the negative electrode and the positive electrode can be prevented, and a decrease in capacity retention rate of the all-solid-state battery including the electrode laminate can be minimized. In addition, even if voids occur in the negative electrode or the solid electrolyte layer, short-circuiting between the positive electrode and the negative electrode can be prevented. In addition, it is possible to minimize the occurrence of metal ion dendrites on the surface of the negative electrode. Here, the distance between the part of the negative electrode that faces the positive electrode and the positive electrode may be the maximum distance from the end of the positive electrode to the negative electrode at which the precipitation rate or the dissolution rate is larger than 0 in the negative electrode.

According to the aspect of the present invention, it is possible to provide an electrode laminate in which the precipitation of metal ions on a positive electrode side surface of the negative electrode is inhibited in a part of the negative electrode that does not face the positive electrode when the all-solid-state battery is charged.

### BRIEF DESCRIPTION OF THE DRAWINGS

FIG. 1 is a cross-sectional view showing an electrode laminate according to one embodiment of the present invention.

FIG. 2 is a cross-sectional view showing the electrode laminate according to one embodiment of the present invention.

FIG. 3 is a diagram showing the relationship between the distance between the part of the negative electrode that faces the positive electrode and the positive electrode and the thickness of the solid electrolyte layer when the precipitation rate of metal ions is considered to be 100% in a case the precipitation rate of metal ions precipitated from the positive electrode is equal to the increment in the thickness of the part of the negative electrode that faces the positive electrode or in a case the dissolution rate of metal ions is considered to be 100% when the dissolution rate of metal ions dissolved from the negative electrode is equal to the decrement in the thickness of the part of the negative electrode that faces the positive electrode.

FIG. 4 is a diagram showing the relationship between the precipitation rate of metal ions or the dissolution rate of metal ions and the thickness of the solid electrolyte layer in a case the precipitation rate of metal ions is considered to be 100% when the precipitation rate of metal ions precipitated from the positive electrode is equal to the increment in the thickness of the part of the negative electrode that faces the positive electrode or in a case the dissolution rate of metal ions is considered to be 100% when the dissolution rate of metal ions dissolved from the negative electrode is equal to the decrement in the thickness of the part of the negative electrode that faces the positive electrode.

FIG. 5 is a diagram showing the relationship between the precipitation rate of metal ions or the dissolution rate of metal ions and the distance between the part of the negative electrode that faces the positive electrode and the positive electrode in a case the precipitation rate of metal ions is considered to be 100% when the precipitation rate of metal ions precipitated from the positive electrode is equal to the increment in the thickness of the part of the negative electrode that faces the positive electrode or in a case the dissolution rate of metal ions is considered to be 100% when the dissolution rate of metal ions dissolved from the negative electrode is equal to the decrement in the thickness of the part of the negative electrode that faces the positive electrode.

FIG. 6 is a diagram representing the results shown in FIG. 3 to FIG. 5 in three dimensions.

FIG. 7 is a cross-sectional view showing the electrode laminate according to one embodiment of the present invention.

FIG. 8 is a cross-sectional view showing the electrode laminate according to one embodiment of the present invention.

FIG. 9 is a cross-sectional view showing the electrode laminate according to one embodiment of the present invention.

FIG. 10 is a cross-sectional view showing the electrode laminate according to one embodiment of the present invention.

### DETAILED DESCRIPTION OF THE INVENTION

Hereinafter, embodiments of the present invention will be described in detail with reference to the drawings.

### Electrode Laminate

### First Embodiment

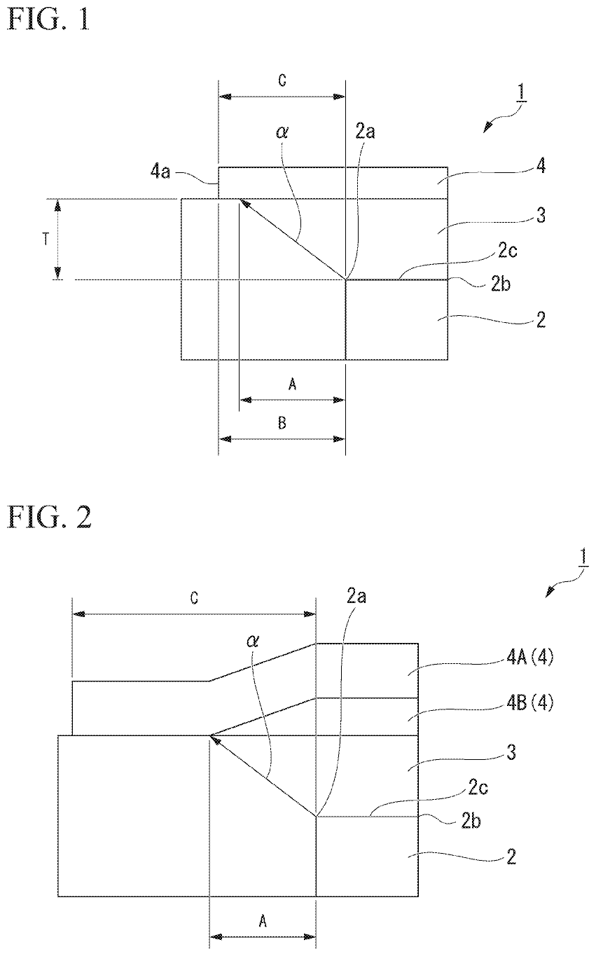

FIG. 1 and FIG. 2 are cross-sectional views showing an electrode laminate of the present embodiment. FIG. 1 shows the electrode laminate before an all-solid-state battery is charged. FIG. 2 shows the electrode laminate after the all-solid-state battery is charged. As shown in FIG. 1, an electrode laminate 1 of the present embodiment includes a positive electrode 2, a solid electrolyte layer 3, and a negative electrode 4.

The solid electrolyte layer 3 is laminated on the positive electrode 2. Specifically, the solid electrolyte layer 3 is disposed on the positive electrode 2 so that it surrounds the outer circumference of the positive electrode 2.

The negative electrode 4 is laminated on the solid electrolyte layer 3. The negative electrode 4 is disposed so that it protrudes beyond the outer circumference of the positive electrode 2 in a direction substantially perpendicular to the thickness direction (lamination direction) of the electrode laminate 1. In other words, in a direction substantially perpendicular to the thickness direction of the electrode laminate 1, the negative electrode 4 extends further outward than the positive electrode 2 in a direction circumferentially outward from the electrode laminate 1. As shown in FIG. 2, after charging the all-solid-state battery, the negative electrode 4 may comprise a negative electrode 4A existing prior to charging and a negative electrode 4B composed of metal ions such as lithium metal precipitated from the positive electrode 2 during charging.

In the electrode laminate 1 of the present embodiment, as shown in FIG. 1, when A is the distance over which metal ions such as lithium ions diffuse from one end 2a of the positive electrode 2 within the solid electrolyte layer 3 in a direction substantially perpendicular to the thickness direction of the electrode laminate 1, B is the distance from the one end 2a of the positive electrode 2 in the solid electrolyte layer 3 to one end 4a of the negative electrode 4 in a direction substantially perpendicular to the thickness direction of the electrode laminate 1, and C is the distance from the one end 2a of the positive electrode 2 to the one end 4a of the negative electrode 4 in the negative electrode 4 in a direction substantially perpendicular to the thickness direction of the electrode laminate 1, A and C satisfy the following formula (1). In FIG. 1, in a cross section of the electrode laminate 1 in the thickness direction, the one end 2a of the positive electrode 2 is one side (a side extending in a direction substantially perpendicular to the plane of the paper) of the positive electrode 2 on the side of an upper surface 2c. In addition, B and C satisfy the relationship B=C.

A≤C (1)

In a case A and C satisfy Formula (1), when the all-solid-state battery including the electrode laminate 1 is charged, it is possible to inhibit the precipitation of a metal on a positive electrode 2 side surface of the negative electrode 4 in a part of the negative electrode 4 that does not face the positive electrode 2. Therefore, a decrease in capacity retention rate of the all-solid-state battery including the electrode laminate 1 can be minimized.

Here, when the electrode laminate 1 does not include the negative electrode 4, but includes an intermediate layer, A≤B is preferable, and A<B is more preferable.

When A and B satisfy the above relationship, it is possible to achieve both an improvement in the volumetric energy density of the all-solid-state battery including the electrode laminate 1 and an improvement in the charging and discharging function.

In addition, when the electrode laminate 1 does not include an intermediate layer, but includes the negative electrode 4 (as in FIGS. 1 and 2), A≤C is preferable, and A<C is more preferable. When A and C satisfy the above relationship, it is possible to achieve both an improvement in the volumetric energy density of the all-solid-state battery including the electrode laminate 1 and an improvement in the charging and discharging function.

Here, in FIG. 1, the line segment indicated by a is a pseudo-illustration of the trajectory of metal ions diffusing from the one end 2a of the positive electrode 2 into the solid electrolyte layer 3. Therefore, the trajectory of diffusing metal ions is not limited to that shown in FIG. 1. The direction in which metal ions precipitated from the one end 2a of the positive electrode 2 diffuse is not particularly limited as long as metal ions move toward the negative electrode 4 within the solid electrolyte layer 3.

In the electrode laminate 1 of the present embodiment, as shown in FIG. 1, when A is the distance over which metal ions diffuse within the solid electrolyte layer 3 in a direction substantially perpendicular to the thickness direction of the electrode laminate 1 from the one end 2a of the positive electrode 2, and T is the thickness of the solid electrolyte layer 3, the distance A over which metal ions diffuse is defined by, for example, the following formula (2). Here, as shown in FIG. 1, the thickness T of the solid electrolyte layer 3 is the thickness of the solid electrolyte layer 3 located above the electrode laminate 1 in the thickness direction from the upper surface 2c of the positive electrode 2.

A=a×T+b (2)

As shown in Formula (2), as the thickness T of the solid electrolyte layer 3 increases, the distance A over which metal ions diffuse increases. When A and T satisfy Formula (2), in a direction substantially perpendicular to the thickness direction of the electrode laminate 1, the metal ions precipitated from the one end 2a of the positive electrode 2 diffuse within the solid electrolyte layer 3 within a region that does not protrude from the negative electrode 4. Therefore, it is possible to inhibit the precipitation of metal dendrites between the solid electrolyte layer and the intermediate layer.

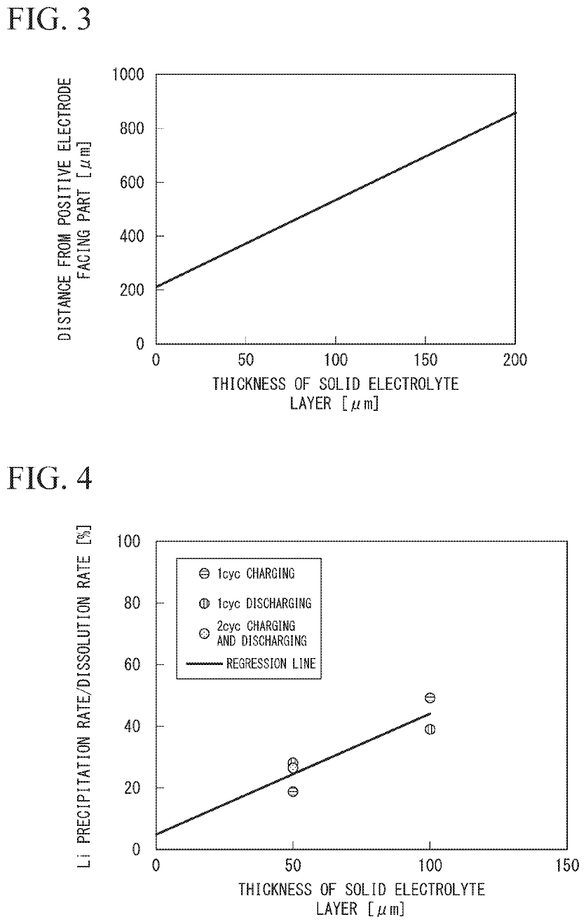

If the precipitation rate of metal ions is considered to be 100% when the precipitation rate of the metal ions precipitated from the positive electrode 2 is equal to the increment in the thickness of the part of the negative electrode 4 that faces the positive electrode 2 or in a case the dissolution rate of metal ions is considered to be 100% when the dissolution rate of the metal ions dissolved from the negative electrode 4 is equal to the decrement in the thickness of the part of the negative electrode 4 that faces the positive electrode 2, the relationship (relationship 1) between the distance between the part of the negative electrode 4 that faces the positive electrode 2 and the positive electrode 2 and the thickness of the solid electrolyte layer 3, is, for example, a relationship as shown in FIG. 3. Based on the results shown in FIG. 3, the formula representing the distance A shown in Formula (2) is derived.

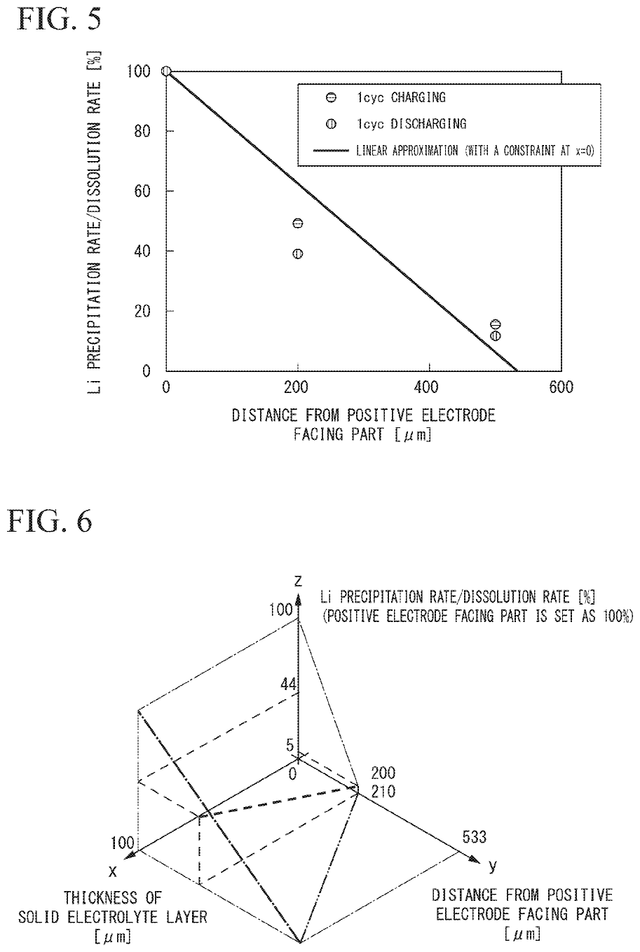

The relationship 1 is derived from the following relationship 2 and the following relationship 3. In a case the precipitation rate of metal ions is considered to be 100% when the precipitation rate of the metal ions precipitated from the positive electrode 2 is equal to the increment in the thickness of the part of the negative electrode 4 that faces the positive electrode 2 or in a case the dissolution rate of metal ions is considered to be 100% when the dissolution rate of the metal ions dissolved from the negative electrode 4 is equal to the decrement in the thickness of the part of the negative electrode 4 that faces the positive electrode 2, the relationship 2 is a relationship between the precipitation rate of metal ions or the dissolution rate of metal ions and the thickness of the solid electrolyte layer. The relationship 2 is, for example, a relationship as shown in FIG. 4. In a case the precipitation rate of metal ions is considered to be 100% when the precipitation rate of the metal ions precipitated from the positive electrode 2 is equal to the increment in the thickness of the part of the negative electrode 4 that faces the positive electrode 2 or in a case the dissolution rate of metal ions is considered to be 100% when the dissolution rate of the metal ions dissolved from the negative electrode 4 is equal to the decrement in the thickness of the part of the negative electrode that faces the positive electrode 2, the relationship 3 is a relationship between the precipitation rate of metal ions or the dissolution rate of metal ions and the distance between the part of the negative electrode 4 that faces the positive electrode 2 and the positive electrode 2. The relationship 3 is, for example, a relationship as shown in FIG. 5.

By representing the results shown in FIG. 3 to FIG. 5 in three dimensions, the results shown in FIG. 6 are obtained. Based on the results shown in FIG. 6, the formula representing the distance A shown in Formula (2) is obtained. Here, numerical values shown in FIG. 3 to FIG. 6 are examples, and these numerical values are appropriately changed depending on the thicknesses and configurations of the positive electrode 2, the solid electrolyte layer 3, and the intermediate layer. Here, numerical values shown in FIG. 6 are examples, and these numerical values are appropriately changed depending on the thicknesses and configurations of the positive electrode 2, the solid electrolyte layer 3, and the negative electrode 4. For example, in FIG. 6, when x=100 μm and y=200 μm, in a case the z-axis value (one-dot dashed line) is larger than the z-axis value (broken line), the larger value is taken as the range of lithium precipitation rate/dissolution rate.

### (Positive Electrode)

The positive electrode 2 includes a positive electrode current collector and a positive electrode active material layer. The side surface of the positive electrode 2 may include an insulation layer (not shown).

### <Positive Electrode Current Collector>

The positive electrode current collector constitutes the positive electrode 2 together with the positive electrode active material layer, and in one embodiment of the present invention, the positive electrode active material layer is laminated on the positive electrode current collector. The area of the positive electrode current collector in a plan view is preferably equal to the area of the positive electrode active material layer in a plan view or larger than the area of the positive electrode active material layer in a plan view. That is, the positive electrode current collector is preferably large enough to cover a positive electrode current collector side surface of the positive electrode active material layer. The shape of the positive electrode current collector is, for example, a plate shape or a foil shape.

The positive electrode current collector is not particularly limited as long as it functions as a current collecting material in the positive electrode 2, and any collector known per se as a positive electrode current collector of the all-solid-state battery can be applied.

Examples of materials constituting the positive electrode current collector include aluminum, aluminum alloys, stainless steel, nickel, iron and titanium, and among these, aluminum, aluminum alloys and stainless steel are preferable, and aluminum is particularly preferable.

### <Positive Electrode Active Material Layer>

As the material constituting the positive electrode active material layer, any material known per se as a material constituting the positive electrode active material layer of the all-solid-state battery can be applied. As the positive electrode active material, for example, a lithium-containing layered active material, a spinel-type active material, an olivine-type active material or the like can be applied, and more specific examples thereof include LiCoO₂, LiNiO₂, LiNiₚMn_{q}CoᵣO₂(p+q+r=1), LiNiₚAl_{q}CoᵣO₂ (p+q+r=1), LiMn₂O₄, compounds represented by Li₁₊ₓMn_{2-x-y}MO₄ (x+y=2, M=at least one element selected from among Al, Mg, Co, Fe, Ni, and Zn), or LiMPO₄ (M=at least one element selected from among Fe, Mn, Co, and Ni), and lithium titanate.

The positive electrode active material layer may contain a solid electrolyte in consideration of charge transfer medium conductivity, may contain a conductivity aid in consideration of conductivity, and may contain a binder in consideration of flexibility.

As the solid electrolyte, the conductivity aid and the binder, those known to be used in the field of positive electrode active material layers of all-solid-state batteries can be applied.

### Solid Electrolyte Layer

The solid electrolyte layer 3 is provided between the positive electrode 2 and the negative electrode 4, and has a function of conducting a charge transfer medium between the positive electrode 2 and the negative electrode 4.

In the electrode laminate 1, the solid electrolyte layer 3 is laminated on the positive electrode active material layer.

The material constituting the solid electrolyte layer 3 is not particularly limited as long as it has conductivity of a charge transfer medium, and examples thereof include a sulfide-based solid electrolyte material, an oxide-based solid electrolyte material, a nitride-based solid electrolyte material, and a halide-based solid electrolyte material. As the sulfide-based solid electrolyte material, for example, a sulfide-based solid electrolyte material formed from a raw material composition containing Li₂S and P₂S₅ can be applied, and a material having an argyrodite-type crystal structure may be used.

Examples of oxide-based solid electrolyte materials include a NASICON-type oxide, a garnet-type oxide, and a perovskite-type oxide.

Examples of NASICON-type oxides include oxides containing Li, Al, Ti, P and O such as Li_{1.5}Al_{0.5}Ti_{1.5}(PO₄)₃). Examples of garnet-type oxides include oxides containing Li, La, Zr and O such as Li₇La₃Zr₂O₁₂. Examples of perovskite-type oxides include oxides containing Li, La, Ti and O such as LiLaTiO₃.

The solid electrolyte layer 3 may further contain a binder, and as such a binder, a binder known to be used in the field of solid electrolyte layers of all-solid-state batteries can be used. Examples of binder materials include polyvinylidene fluoride (PVdF), polymethyl methacrylate (PMMA), polyisobutene (PIB), styrene butadiene rubber (SBR), polyethylene-vinyl acetate copolymer (PEVA), nitrile rubber (NBR), and hydrogenated nitrile rubber (HNBR). These may be used alone or two or more thereof may be used in combination.

In one embodiment, the material of the solid electrolyte layer 3 is preferably in the form of particles, and preferably has, for example, a median diameter (D50) of 0.5 μm to 10 μm.

### Negative Electrode

The negative electrode 4 includes a negative electrode current collector and a negative electrode active material layer. In addition, the negative electrode 4 is formed of metallic lithium.

### Negative Electrode Current Collector

The negative electrode current collector constitutes the negative electrode 4 together with the negative electrode active material layer, and in one embodiment of the present invention, the negative electrode active material layer is laminated on the solid electrolyte layer 3, and the negative electrode current collector is laminated on the negative electrode active material layer. Alternatively, the negative electrode 4 formed of metallic lithium or the like is laminated on the solid electrolyte layer 3. The shape of the negative electrode current collector is, for example, a plate shape or a foil shape.

The negative electrode current collector is not particularly limited as long as it functions as a current collecting material in the negative electrode 4, and any collector known per se as a negative electrode current collector of the all-solid-state battery can be applied.

Examples of materials constituting the negative electrode current collector include nickel, copper, and stainless steel, and among these, copper is preferable.

### Negative Electrode Active Material Layer

The negative electrode active material layer has a function of absorbing and releasing metal ions. As the material constituting the negative electrode active material layer, any material known per se a material constituting the negative electrode active material layer of the all-solid-state battery can be applied. Examples of negative electrode active materials include metallic lithium, lithium alloys, metal oxides, metal sulfides, metal nitrides, Si, SiO, and carbon materials. Examples of carbon materials include artificial graphite, natural graphite, hard carbon, and soft carbon.

As necessary, the negative electrode active material layer may further contain a conductivity aid, a binder and the like. As the conductivity aid or binder, those known to be used in the field of negative electrode active material layers of all-solid-state batteries can be applied.

The negative electrode 4 may be composed of metal ions such as lithium metal precipitated from the positive electrode 2, or it may be a conductive layer that does not contain lithium. In a case the negative electrode 4 is composed of metal ions such as lithium metal precipitated from the positive electrode 2, this includes cases where the metal ions precipitate during the initial charging of the all-solid-state battery and the negative electrode is formed from those metal ions.

In one embodiment, at least a part of either end of the negative electrode current collector in the X direction may be extended in the X direction to form a negative electrode tab (not shown), and at least a part of either end of the positive electrode current collector in the X direction may be extended in the X direction to form a positive electrode tab (not shown). The negative electrode tab and the positive electrode tab preferably extend in opposite directions in the X direction. With such a configuration, when a plurality of electrode laminates 1 are laminated, the positive electrodes and the negative electrode can be easily connected in parallel.

When the all-solid-state battery including the electrode laminate 1 is charged, as shown in FIG. 2, a metal 5 is precipitated on the negative electrode 4. According to the electrode laminate 1 of the present embodiment, it is possible to inhibit the precipitation of a metal on a positive electrode 2 side surface of the negative electrode 4 in a part of the negative electrode 4 that does not face the positive electrode 2 when the all-solid-state battery is charged.

### Second Embodiment

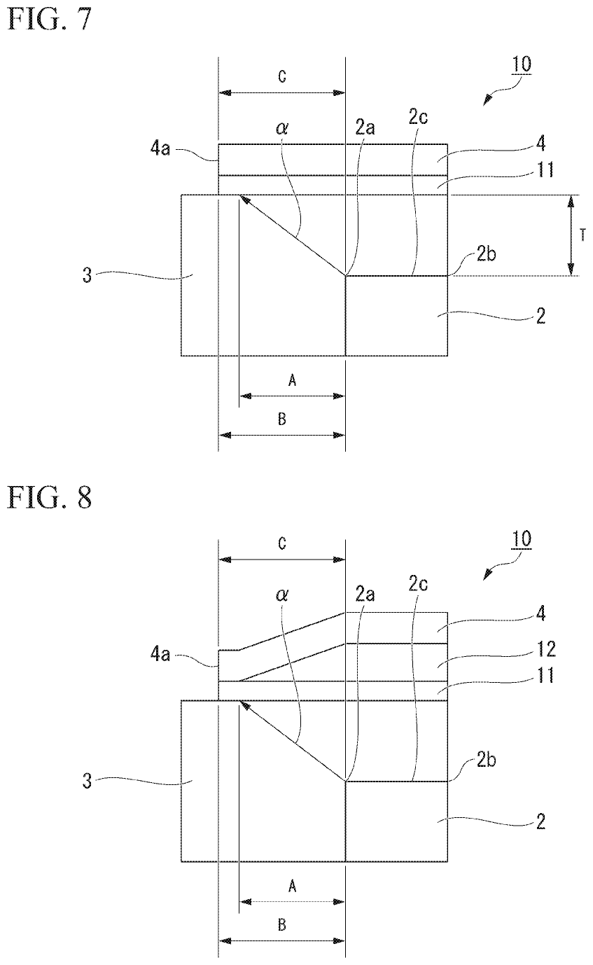

FIG. 7 and FIG. 8 are a cross-sectional view showing an electrode laminate of the present embodiment. FIG. 7 shows an electrode laminate before the all-solid-state battery is charged. FIG. 8 shows an electrode laminate after the all-solid-state battery is charged. In FIG. 7 and FIG. 8, the same components as the components shown in FIG. 1 and FIG. 2 are denoted with the same reference numerals, and the descriptions thereof will be omitted. As shown in FIG. 7, an electrode laminate 10 of the present embodiment includes the positive electrode 2, the solid electrolyte layer 3, the negative electrode 4, and an intermediate layer 11.

The intermediate layer 11 is provided between the solid electrolyte layer 3 and the negative electrode 4. The intermediate layer 11 is disposed to protrude beyond the outer circumference of the positive electrode 2 in a direction substantially perpendicular to the thickness direction (lamination direction) of the electrode laminate 1. In other words, a length of the intermediate layer 11 is longer than a length of the positive electrode 2 in a direction circumferentially outward from the electrode laminate 1 in a direction substantially perpendicular to the thickness direction of the electrode laminate 1.

In the electrode laminate 10 of this embodiment, as shown in FIG. 7, a distance A is defined as a distance in which the metal ions, such as lithium ions, diffuse within the solid electrolyte layer 3 in the direction substantially perpendicular to the thickness direction of the electrode laminate 10 from end 2a of the positive electrode 2, a distance B is defined as a distance in the solid electrolyte layer 3 from the end 2a of the positive electrode 2 to an end 4a of the negative electrode 4 in a direction substantially perpendicular to the thickness direction of the electrode laminate 10, and a distance C is defined as a distance in the negative electrode 4 from the end 2a of the positive electrode 2 in a direction substantially perpendicular to the thickness direction of the electrode laminate 10 toward the end 4a of the negative electrode 4. In other words, the distance B substantially indicates the distance from the end 2a of the positive electrode 2 to the intermediate layer 11.

In the electrode laminate 10 of the present embodiment, the larger of B and C is equal to or larger than A. In the electrode laminate 10 of the present embodiment shown in FIG. 8, B and C are equal (B=C). Therefore, in the electrode laminate 10 of the present embodiment, B and C are equal to or larger than A. Therefore, it is possible to inhibit the precipitation of metal ions on a positive electrode 2 side surface of the negative electrode 4 in a part of the negative electrode 4 that does not face the positive electrode 2 when the all-solid-state battery including the electrode laminate 10 is charged. Therefore, a decrease in capacity retention rate of the all-solid-state battery including the electrode laminate 10 can be minimized.

In addition, when the electrode laminate 10 includes the negative electrode 4 and the intermediate layer 11, B≤C is preferable. When B and C satisfy the above relationship, it is possible to inhibit the precipitation of metallic lithium on a positive electrode 2 side surface of the negative electrode 4 in a part of the negative electrode 4 that does not face the positive electrode 2 when the all-solid-state battery is charged. Therefore, short-circuiting between the negative electrode 4 and the positive electrode 2 can be prevented, and a decrease in capacity retention rate of the all-solid-state battery including the electrode laminate 10 can be minimized. In addition, even if voids occur in the intermediate layer 11 or the solid electrolyte layer 3, short-circuiting between the positive electrode 2 and the negative electrode 4 can be prevented. In addition, it is possible to minimize the occurrence of dendrites derived from metal ions on the surface of the intermediate layer 11.

In the electrode laminate 10 of the present embodiment, the distance A over which metal ions diffuse is defined by, for example, Formula (2).

### Intermediate Layer

The intermediate layer 11 is laminated on the solid electrolyte layer 3.

When the intermediate layer 11 is provided, it is possible to minimize abnormal precipitation of metal ions.

The intermediate layer 11 preferably has electron conductivity and voids through which metal ions such as lithium ions, which are charge transfer media, can pass. Because the intermediate layer 11 has voids, when the all-solid-state battery is charged, metal ions that move from the solid electrolyte layer 3 toward the upper surface of the intermediate layer 11 pass through the intermediate layer 11, and are precipitated on the upper surface of the intermediate layer 11. By passing through the intermediate layer 11, the metal precipitation layer can be uniformly formed on the surface of the intermediate layer 11.

The porosity of the intermediate layer 11 is preferably higher than the porosity of the solid electrolyte layer 3. Therefore, since many voids through which metal ions can pass are formed within the intermediate layer 11, a metal can be more uniformly precipitated on the surface of the intermediate layer 11. The porosity of the intermediate layer 11 may be, for example, 40% to 70%.

The material forming the intermediate layer 11 preferably contains amorphous carbon and metal nanoparticles. The intermediate layer 11 may further contain a binder as a binding material in order to maintain the structure.

Since amorphous carbon is less likely to form an alloy with a metal such as lithium, it can minimize the formation of dendrites, and improve cycle characteristics of all-solid-state batteries. The amorphous carbon may be easily graphitizable carbon (also called soft carbon) or non-graphitizable carbon (also called hard carbon). In addition, the amorphous carbon may be any of carbon allotropes that do not exhibit a distinct crystalline state, and may be an aggregate of fine graphite crystals. Examples of amorphous carbon include carbon blacks such as acetylene black, furnace black, and ketjen black, coke, activated carbon, carbon nanotubes (CNT), fullerene, and graphene. Examples of metal nanoparticles include metal nanoparticles of tin (Sn), silicon (Si), zinc (Zn), magnesium (Mg), gold (Au), platinum (Pt), palladium (Pd), silver (Ag), aluminum (Al), bismuth (Bi), and antimony (Sb). The content of the metal nanoparticles is preferably more than 0 mass % and 30 mass % or less with respect to the mass of the intermediate layer 11. When the intermediate layer 11 contains metal nanoparticles, the electron conductivity of the intermediate layer 11 can be increased and a metal can be more uniformly precipitated. In addition, since the metal nanoparticles have a higher Young's modulus than amorphous carbon, the structure of the intermediate layer 11 can be maintained even when high-pressure pressing is performed during production of all-solid-state batteries.

The particle size of the particles such as amorphous carbon and metal nanoparticles is preferably smaller than the particle size of the solid electrolyte material. Therefore, since the intermediate layer 11 can enter the gaps between the solid electrolyte materials constituting the interface of the solid electrolyte layer 3, the contract area between the solid electrolyte layer 3 and the intermediate layer 11 can be increased, and adhesion can be improved. The particle size of the amorphous carbon may be, for example, in a range of 0.02 μm to 0.10 μm in terms of the median diameter (D50), and the particle size of the metal nanoparticles may be, for example, in a range of 0.02 μm to 0.20 μm in terms of the median diameter (D50).

The binder of the intermediate layer 11 is preferably one that can improve the adhesion between the particles constituting the intermediate layer 11, and between the intermediate layer 11 and the solid electrolyte layer 3. The binder is not particularly limited, and any binder generally used in all-solid-state batteries can be used. Examples of materials of the binder of the intermediate layer 11 include acrylic acid polymers, cellulose polymers, styrene polymers, vinyl acetate polymers, urethane polymers, fluoroethylene polymers, and PVDF polymers.

When the all-solid-state battery including the electrode laminate 10 is charged, as shown in FIG. 8, a metal 12 such as metallic lithium is precipitated between the intermediate layer 11 and the negative electrode 4. According to the electrode laminate 10 of the present embodiment, it is possible to inhibit the precipitation of metallic lithium on a positive electrode 2 side surface of the negative electrode 4 in a part of the negative electrode 4 that does not face the positive electrode 2 when the all-solid-state battery is charged.

### Third Embodiment

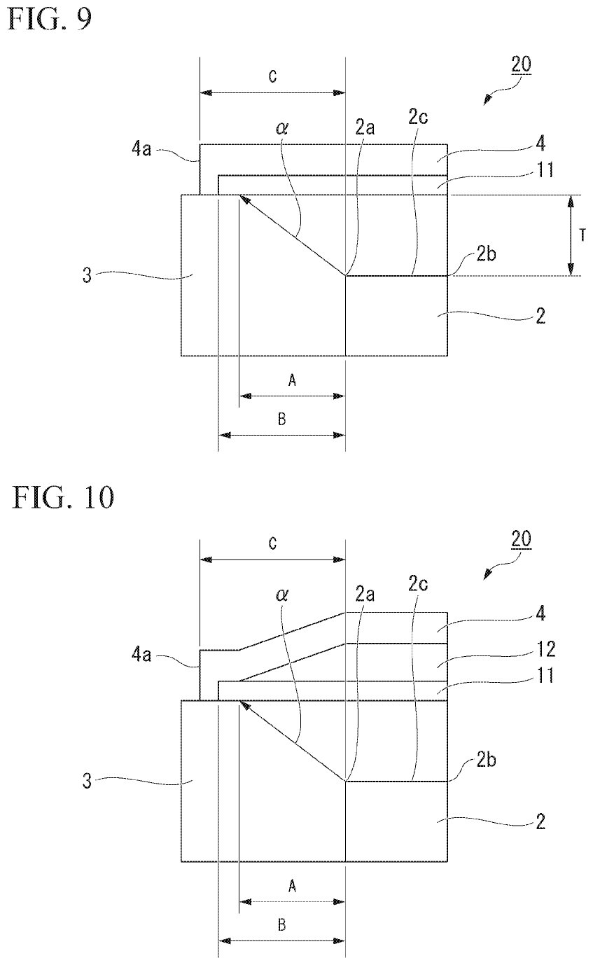

FIG. 9 and FIG. 10 are cross-sectional views showing an electrode laminate of the present embodiment. FIG. 9 shows an electrode laminate before the all-solid-state battery is charged. FIG. 10 shows an electrode laminate after the all-solid-state battery is charged. In FIG. 9 and FIG. 10, the same components as the components shown in FIG. 1 and FIG. 2 are denoted with the same reference numerals, and the descriptions thereof will be omitted. As shown in FIG. 9, an electrode laminate 20 of the present embodiment includes the positive electrode 2, the solid electrolyte layer 3, the negative electrode 4, and the intermediate layer 11.

In the electrode laminate 20 of the present embodiment, the larger of B and C is equal to or larger than A. In the electrode laminate 20 of the present embodiment, B and C satisfy the relationship B<C. Therefore, in the electrode laminate 20 of the present embodiment, C is equal to or larger than A. Therefore, it is possible to inhibit the precipitation of metal ions on a positive electrode 2 side surface of the negative electrode 4 in a part of the negative electrode 4 that does not face the positive electrode 2 when the all-solid-state battery including the electrode laminate 20 is charged.

Therefore, a decrease in capacity retention rate of the all-solid-state battery including the electrode laminate 20 can be minimized.

In addition, in the electrode laminate 20 of the present embodiment, when B<C is satisfied, it is possible to inhibit the precipitation of metallic lithium on a positive electrode 2 side surface of the negative electrode 4 in a part of the negative electrode 4 that does not face the positive electrode 2 when the all-solid-state battery is charged. Therefore, short-circuiting between the negative electrode 4 and the positive electrode 2 can be prevented, and a decrease in capacity retention rate of the all-solid-state battery including the electrode laminate 20 can be minimized. In addition, even if voids occur in the intermediate layer 11 or the solid electrolyte layer 3, short-circuiting between the positive electrode 2 and the negative electrode 4 can be prevented. In addition, it is possible to minimize the occurrence of dendrites derived from metal ions on the surface of the intermediate layer 11.

In the electrode laminate 20 of the present embodiment, the distance A over which metal ions diffuse is also defined by, for example, Formula (2).

When the all-solid-state battery including the electrode laminate 20 is charged, as shown in FIG. 10, the metal 12 such as metallic lithium is precipitated between the intermediate layer 11 and the negative electrode 4. According to the electrode laminate 20 of the present embodiment, it is possible to inhibit the precipitation of metallic lithium on a positive electrode 2 side surface of the negative electrode 4 in a part of the negative electrode 4 that does not face the positive electrode 2 when the all-solid-state battery is charged.

While the embodiments of the present invention have been described above in detail, the present invention is not limited to the above embodiments, and various modifications and changes can be made within the scope of the present invention described in the scope of claims.

1. A electrode laminate comprising a positive electrode, a solid electrolyte layer laminated on the positive electrode, and a negative electrode laminated on the solid electrolyte layer,
wherein, when A is a distance over which lithium ions diffuse within the solid electrolyte layer in a direction substantially perpendicular with respect to a thickness direction of the electrode laminate from one end of the positive electrode, B is a distance from the one end of the positive electrode in the solid electrolyte layer to one end of the negative electrode in the direction substantially perpendicular with respect to the thickness direction of the electrode laminate, and C is a distance from the one end of the positive electrode to the one end of the negative electrode in the negative electrode in the direction substantially perpendicular with respect to the thickness direction of the electrode laminate, the A and the C satisfy the following formula (1):
A≤C (1).

2. The electrode laminate according to claim 1,
wherein an intermediate layer is provided between the solid electrolyte layer and the negative electrode, and
a larger one of the B and the C is equal to or larger than the A.

3. The electrode laminate according to claim 1,
wherein, in a case a precipitation rate of metal ions is considered to be 100% when the precipitation rate of metal ions precipitated from the positive electrode is equal to an increment in a thickness of a part of the negative electrode that faces the positive electrode or in a case a dissolution rate of metal ions is considered to be 100% when the dissolution rate of metal ions dissolved from the negative electrode is equal to a decrement in the thickness of the part of the negative electrode that faces the positive electrode, the A is derived based on a relationship 1 which is a relationship between a distance between the part of the negative electrode that faces the positive electrode and the positive electrode and a thickness of the solid electrolyte layer.

4. The electrode laminate according to claim 3, wherein the relationship 1 is derived from a relationship 2 which is a relationship between the precipitation rate of metal ions or the dissolution rate of metal ions and the thickness of the solid electrolyte layer and a relationship 3 which is a relationship between the precipitation rate of metal ions or the dissolution rate of metal ions and the distance between the part of the negative electrode that faces the positive electrode and the positive electrode.
